(19) United States
(12) Patent Application Publication
(10) Pub. No.: US 2010/0239875 A1
(43) Pub. Date: Sep. 23, 2010

(54) COATING FOR WOOD MATERIALS AND METHOD FOR THE PRODUCTION THEROF

(75) Inventors: Dieter Lehmann, Coswig (DE); Michaela Gedan-Smolka, Grosskmehlen (DE); Antje Taeger, Dresden (DE); Marcel Tuschla, Dresden (DE); Bjoern Lilie, Wittingen (DE)

Correspondence Address: GREENBLUM & BERNSTEIN, P.L.C., 1950 ROLAND CLARKE PLACE, RESTON, VA, 20191, US

(73) Assignees: INSTITUT FUER HOLZTECHNOLOGIE GGMBH, Dresden (DE); Leibniz Fuer Polymerforschung Dresden E.V., Dresden (DE)

(21) Appl. No.: 12/680,260

(22) PCT Filed: Sep. 29, 2008
(86) PCT No.: PCT/EP08/63014

§ 371 Date: Mar. 26, 2010

(30) Foreign Application Priority Data
Oct. 1, 2007 (DE) 10 2007 000 806.8

(51) Int. Cl. B32B 21/04; B05D 1/02; B05D 1/18; B05D 7/06; B05D 3/02

(52) U.S. Cl. 428/535; 427/209; 427/440; 428/537.1; 427/427.7; 427/397

(57) ABSTRACT

The invention relates to the field of chemistry and relates to a coating for wood materials, which serves as a basis for subsequent coatings. The object of the present invention is to disclose a coating, with the aid of which the conductivity of the wood materials is improved. The object is attained by a coating, in which the outer and/or inner surface of a wood material is provided with polyelectrolytes which were dissolved or are or were dispersed in water and/or an organic solvent at least up to processing, with a largely uniform distribution and wherein at least 10 g polyelectrolyte is present per square meter. The object is further attained through a method in which an aqueous solution and/or dispersion of polyelectrolytes is applied on the outer and/or inner surface of wood materials, wherein at least 10 g cationized polyelectrolyte solid is applied per square meter coated outer and/or inner surface of the wood material.

The invention relates to the field of chemistry and relates to a coating for wood materials, which serves as a basis for the subsequent coating with powder coatings or other surface layers and a method for the production thereof.

Wood materials are often to be provided with surface layers, in order on the one hand to protect the surface or also to improve their surface properties. In order to be able to apply surface layers such as, e.g., powder coating layers or in order to avoid electrostatic charges of wood materials, e.g., with flooring structures (such as, e.g., parquet and/or laminate floors) which serves to protect people and technical equipment and to reduce dust formation, it is necessary for the wood materials and/or the wood surfaces to be conductive in the electrostatic sense. For example, for the electrostatic application of powder coatings on wood materials by means of electrostatic application a reduction of the specific surface resistance from >10¹¹ Ohm in standard atmosphere [20° C., 65% relative atmospheric humidity] to <10⁹ Ohm in standard atmosphere is required.

This necessary minimum conductivity was previously realized by an increased moisture content, preheating, but primarily through the addition of internal antistatic agents based on quaternary ammonium compounds [EP 1382637 A2, WO 00/16911], alkyl sulfonates [WO/2008/046890] or other frequently halogen-containing alkaline salts or earth alkaline salts [EP 1 382 637 A2]. It is known that low-molecular additives of this type tend to deplete from the matrix due to migration and elution processes, which ultimately results in the gradual loss of the antistatic effect. Furthermore, through the salts used, the resistance of the materials to the effect of moisture is often also impaired.

Furthermore, halogen-containing additives according to the Ordinance on the disposal of waste wood, dated Aug. 15, 2002 (German gazette of federal law, Part I, no. 59, dated Aug. 23, 2003) can be used only up to a permissible limit value (600 mg chlorine per 1 kg dry matter substrate).

Furthermore, it is known that cellulose can be cationized. A direct amination of cellulose, e.g., using ammonia, is not possible [Th. Lieser; Kurzes Lehrbuch der Cellulosechemie (1953) p. 21]. However, according to Heinze et al., it is possible to introduce amino groups after tosylation of the cellulose [Th. Heinze, H.-P. Rahn; Macromol. Symp., 1997, 129, 103].

Chitosan, as a naturally occurring amino cellulose, can be converted into cationized cellulose by alkylation in one step. The synthesis is one-stage and not complex. However, the relatively high price of the initial product chitosan argues against practical relevance.

Another method for producing cationic derivatives of polysaccharides was disclosed by E. Gruber et al.; Das Papier December 1996 p. 729 ff.

Using epichlorohydrin and tertiary amines (A/E method), both are standard chemicals and thus low in price, the cationization can be carried out in one step according to the following equation 1.

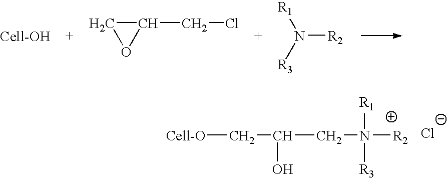

Equation 1: Synthesis of a cationic polyelectrolyte based on cellulose according to the A/E method

The conversion can be catalyzed by the addition of 1,4-diazabicyclo(2.2.2)octane [DABCO)].

Alternatively to the conversion with epichlorohydrin and tertiary amines, polysaccharides can be cationized with glycidyl trimethyl ammonium chloride in one step, equation 2.

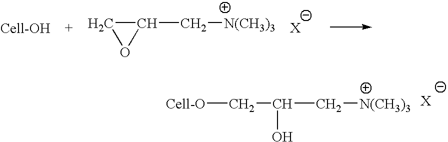

Equation 2: Synthesis of a cationic polyelectrolyte based on cellulose through conversion with glycidyl trimethyl ammonium chloride.

1-methylimidazole can be added as a catalyst.

It is a disadvantage of the previously known methods for improving the conductivity of wood materials that the halogen-containing additives are limited in their amount used and the improvement of conductivity did not have a long-term effect with the increase in the migration and elution processes. Furthermore, the mechanical material properties (such as, e.g., bending strength, transverse tensile strength and swelling behavior) and the surface properties of the coated wood materials are not improved with the previously known methods.

The object of the present invention is to disclose a coating for wood materials, with the aid of which the conductivity of the wood materials and the surface properties of the coated wood materials are improved and to disclose a method for the production thereof which is more environmentally friendly.

The object is attained with the invention described in the claims. Advantageous embodiments are the subject matter of the subordinate claims.

With the coating of wood materials according to the invention the outer and/or inner surface of a wood material is provided with a coating comprising a polyelectrolyte or a mixture of polyelectrolytes which have been dissolved or have been or are dispersed in water and/or an organic solvent at least up to processing as a coating, wherein a largely uniform distribution of the coating is realized and wherein at least 10 g polyelectrolyte is present per square meter coated outer and/or inner surface of the wood material.

Advantageously the coating comprises cationic and/or anionic polyelectrolytes or a mixture thereof, wherein even more advantageously the coating of cationic and anionic polyelectrolytes is dissolved and/or dispersed in a solvent and/or solvent mixture at least up to processing.

Furthermore advantageously, the polyelectrolytes are based on cellulose or cellulose derivatives.

Likewise advantageously, at least 20 g, even more advantageously 30 to 50 g, cationic polyelectrolyte is present per square meter coated outer and/or inner surfaces of the wood material.

And also advantageously, the outer surface of a wood material is coated, wherein even more advantageously at least 80% of the outer surface of a wood material is coated, wherein a largely uniform distribution of the coating is realized.

It is also advantageous when the surfaces of the ground wood components of a wood material are coated as an inner surface.

It is likewise advantageous if the surfaces of the wood fibers of a wood fiber material are coated.

It is also advantageous if a largely uniform distribution of the coating on the inner surface of a wood material is present.

It is also advantageous if at least 80% of the inner surface of a wood material is coated, wherein at least a reticular connection between the coating materials is present in the form of a percolation network.

It is likewise advantageous if strong polyelectrolytes are present.

It is also advantageous if the polyelectrolyte or polyelectrolytes are dispersed in water and/or in organic solvents that have water-like properties, wherein advantageously ethanol and/or methanol and/or formic acid and/or acetic acid are present as organic solvents.

In the method according to the invention for producing a coating for wood materials, an aqueous solution and/or dispersion of a polyelectrolyte or a mixture of polyelectrolytes or a solution and/or dispersion of one or more organic solvents and of a polyelectrolyte or a mixture of polyelectrolytes or a solution and/or dispersion of aqueous organic solvents and of a polyelectrolyte or a mixture of polyelectrolytes is applied onto the outer and/or inner surface of wood materials, wherein at least 10 g cationized polyelectrolyte solid is applied per square meter coated outer and/or inner surface of the wood material.

Advantageously, a polyelectrolyte or a mixture of only anionic or only cationic or anionic and cationic polyelectrolytes is used as a polyelectrolyte.

Likewise advantageously polyelectrolytes based on cellulose or cellulose derivatives are used.

Also advantageously the outer wood surfaces are coated.

Furthermore advantageously, the surface of wood components that are processed to form a wood material are coated, wherein even more advantageously wood fibers or wood chips are coated and subsequently compressed or further processed to form a wood material.

It is also advantageous if an aqueous solution with a concentration of cationic and/or anionic polyelectrolytes of at least 10-30% is used.

It is furthermore advantageous if a solution of an organic solvent with a concentration of cationic and/or anionic polyelectrolytes of at least 10-30% is used.

It is also advantageous if strong polyelectrolytes or mixtures thereof are used.

It is also advantageous if the coating is applied onto the outer and/or inner surfaces of wood materials by spraying, pouring, knife coating, pressing, tumbling, swirling, dipping, mixing.

And it is also advantageous if the coated surfaces are dried.

It is likewise advantageous if the coated surfaces are subsequently fed to a further processing.

Through the solution according to the invention it is possible to obtain permanently conductive surfaces of wood materials that also have improved surface properties, such as, for example, lower roughness, etc. and improved material properties, such as, e.g., higher tearing strength and bending strength, and are free from halogen harmful to the environment.

To this end the coating according to the invention is applied onto the outer and/or inner surface of wood materials. Within the scope of the invention, outer surfaces means all of the directly accessible surfaces of wood materials. Within the scope of the invention the inner surfaces mean the particle surfaces inside a wood material, such as, for example, wood chips or wood fibers, which are located inside the material after the processing to form compact materials.

With the coating according to the invention, as already stated above, the use of halogen-containing products that are harmful to the environment can be avoided without the properties of the coated wood materials being impaired.

This is possible since halogen-free polyelectrolytes can be obtained, for example through anion exchange, equation 3.

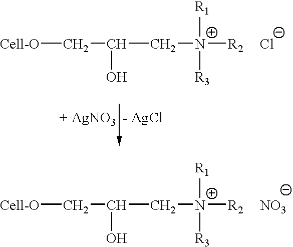

Equation 3: Production of a halogen-free cationized cellulose or cellulose derivatives through anion exchange.

Furthermore, one advantage of this invention is to be seen in that with the use of polyelectrolytes based on cellulose or cellulose derivatives, characteristic substances are used and these are available inexpensively.

To realize an improved conductivity it is necessary for the coating according to the invention to realize a spacing between its conductive groups such that the material becomes conductive. To this end a minimum quantity of polyelectrolyte is necessary and a corresponding distribution of the polyelectrolyte on and optionally in the wood material must be realized. These requirements are described by the percolation theory and must be realized according to the invention.

The good distribution of the polyelectrolyte in the wood material can be realized in a particularly advantageous manner through a reticular connection or a percolation network between the conductive groups.

The quantity of polyelectrolyte is sufficient when the percolation threshold has been reached and the conductivity thus sharply increases.

The coating according to the invention is
Conductive
Antistatic, which is expressed in the reduced specific surface resistance; comparably good antistatic values are achieved thereby, as has been shown with low-molecular quaternary ammonium compounds;
Permanently antistatic, i.e., stable under processing and use conditions, stable in storage; this is achieved through the suppression of migration processes;
Provided with a low roughness of the outer wood surfaces;
Polymer-bonded, whereby in contrast to low-molecular quaternary ammonium compounds as known coating means, a better binding and embedding of the coating means onto and into the wood matrix is achieved;
Compatible with other components [fibrous materials, binders, paint systems], i.e., no undesirable chemical reactions, such as, for example, inhibition or deactivation of the paint catalyst during subsequent painting of the wood surface, no acceleration of the catalysis by the coating materials, etc.;
Water-soluble, whereby explosion-proof requirements during the incorporation no longer apply;
Realizable in a halogen-free manner, and therefore environmentally friendly;
Inexpensive.

With the solution according to the invention, the special suitability of polyelectrolytes as a coating for reducing the specific surface resistance was recognized.

It was also established thereby that the use of strong polyelectrolytes provides a further improvement in the desired results.

Furthermore, polyelectrolytes are known to be water-soluble, wherein this can be good to a greater or lesser extent. If the water-solubility is not good, the polyelectrolytes tend to aggregate, whereby the polyelectrolytes form swollen gels. Gels are no longer a solution of a polyelectrolyte, but should be present as a dispersion according to the invention.

Accordingly, in the present invention the coating can comprise applied, previously dissolved polyelectrolytes, but also previously dispersed polyelectrolytes or polyelectrolytes still present in dispersed form (polyelectrolyte gels). This always depends on the selection of the respective polyelectrolyte and the solvent systems used.

If a mixture of anionic and cationic polyelectrolytes is used, it should be ensured in particular that they are present dissolved and/or dispersed in a solvent or a solvent mixture, depending on the composition at least up to processing as a coating.

Polyelectrolytes are usually water-soluble compounds, since they are polymeric salts. Furthermore, there are also organic solvents that can also dissolve salts in a similar manner to water. These then have water-like properties.

Organic solvents of this type with water-like properties are known as protic (e.g., methanol, formic acid, acetic acid, etc.) or aprotic dipolar (DMF, DMAc, NMP, DMSO, HMPT, etc.) solvents.

For example, carboxymethyl cellulose, cellulose sulfate, polyacrylic acid and polyethyleneimine can be cited as weak polyelectrolytes and sodium-polystyrene sulfonate, polydiallyl dimethyl ammonium chloride, polyallylamine hydrochloride and the salts of weak polyelectrolytes, as strong polyelectrolytes. Table 1 thereby shows the antistatic effect of strong (additives 1-3) and weak (additives 4, 5) polyelectrolytes as a function of the conditioning.

TABLE 1

| | | R[Ohm] | R[Ohm] |
|---|---|---|---|
| | | Standard | Dry |
| Additive | Polyelectrolyte | atmosphere | atmosphere |
| 1 | Sodium-polystyrene sulfonate | 2.1 × 10⁶ | ⁻10⁷ |
| 2 | Polydiallyl dimethyl ammonium | 2.8 × 10⁶ | ⁻10⁷ |
| | chloride | | |
| 3 | Polyallylamine hydrochloride | 5.6 × 10⁶ | ⁻10⁷ |
| 4 | Polyacrylic acid | 8.5 × 10⁹ | ⁻10¹⁰ |
| 5 | Polyethylenimine | 8.9 × 10⁹ | −10¹⁰ |

The polyelectrolytes were applied by knife coating on the outer surface of a medium-density fiberboard (MDF board) in a quantity of respectively 20 g/m².

The coating according to the invention furthermore also leads to an improvement of the material properties including the surface properties of the wood materials.

A cationic polyelectrolyte or a mixture of cationic polyelectrolytes based on cellulose or cellulose derivatives were used, among other things, for the coating according to the invention. The good binder properties of these polysaccharides were also taken into consideration thereby, which lead to a very good compatibility of the coating with the wood material to be coated.

These polysaccharides form the polymer matrix, bound to which positively charged tertiary ammonium groups are present. These polymer-bound cations and the associated non-polymer-bound low-molecular negative counterions are present permanently ionized regardless of the pH value, which leads to the antistatic effect of the coating.

The development of quaternary ammonium salts based on cellulose was therefore favored.

Further advantages of these polyelectrolytes according to the invention are
no pronounced inherent color,
temperature-resistance up to at least 200° C.,
low cost.

The methods known according to the prior art for cationization of celluloses (see equations 1 and 2) were applied to carboxymethyl cellulose (CMC). Carboxymethyl cellulose is particularly suitable as a polymer matrix, since it is not only inexpensive, but also already water-soluble before the polymer-analogous conversion.

Different test variants were examined for the optimization of the syntheses according to equations 1 and 2:
Reaction according to both methods in aqueous solution without catalyst
Reaction according to both methods in aqueous solution with catalyst, thereby variation of the catalyst concentration
Reaction according to both methods in substance without catalyst
Reaction according to both methods in substance with catalyst

The total cationization was determined colorimetrically according to a known method [E. Gruber, Th. Ott; Das Papier 49 (1995), no. 6, 289-296].

Wood materials that are subsequently further coated, for example, through the electrostatic application of powder coatings can be provided with the coatings according to the invention. The antistatic effect of the coating results in a good adhesion of the powder coating particles during application and during baking.

Furthermore, the variation of the application of the coating is expanded by the possibility through the invention of also coating the inner surfaces of the wood materials. For example, a wood material, the inner surface of which is coated, can still be processed after the coating, for example, by milling out and sinking parts and openings. These now new outer surfaces also have the same antistatic effect as the unprocessed areas. A further coating with powder coatings is thus easily possible.

After the cationization of the cellulose or cellulose derivatives and conversion into a halogen-free product by means of anion exchange and application of the coating onto a wood substrate, it is shown that the coating has a very good antistatic effectiveness that improves the surface. It was possible to reduce the surface resistance in the order of magnitude 10⁷ Ohm (standard atmosphere conditioning).

The invention is explained in more detail below based on an exemplary embodiment.

### EXAMPLE

Carboxymethyl cellulose (CMC) is cationized by a method known from the literature [Gruber et al.; Das Papier December 1996 p. 729 ff].

The halogen-containing polyelectrolyte is subjected to an anion exchange, wherein the chloride ions are replaced by nitrate ions as negatively charged counterions.

A 20% by weight solution of the halogen-free product in water is produced.

20 g of this solution is evenly applied to a medium density fiberboard (MDF board) 0.2 m² in size using a doctor knife.

The coated board is conditioned in standard atmosphere (20° C., 65% relative atmospheric humidity) over 21 days.

Subsequently, the specific surface resistance is determined by means of a high-impedance measuring instrument according to DIN EN 61340-2-1 to be 9.5×10⁶ Ohm. The measurement is repeated in dry atmosphere after conditioning of the coated board. The values obtained lie in the range of the low-molecular Kauropal S, a compound currently commercially available for the antistatic equipping of wood materials.

TABLE 2
Surface resistance R [Ohm] as a function of the conditioning
after application on the surface of MDF boards [additive concentration
respectively 20 g per m² substrate surface]

| | Additive | | | |
|---|---|---|---|---|
| | Cationized cellulose | | Kauropal S | |
| | R Standard | R Dry | R Standard | R Dry |
| Application | atmosphere | atmosphere | atmosphere | atmosphere |
| Outer surface | 9.5 × 10⁶ | 10⁷ | 10⁶ | 10⁷ |

The surface properties are clearly improved (smoothed) through the coating according to the invention compared to the commercially available products, which is an advantage for subsequent coatings, e.g., with powder coating.

An environmentally friendly coating is obtained.

1. Coating of wood materials, in which the outer and/or inner surface of a wood material is provided with a coating comprising a polyelectrolyte or a mixture of polyelectrolytes which have been dissolved or have been or are dispersed in water and/or an organic solvent at least up to processing as a coating, wherein a largely uniform distribution of the coating is realized and wherein at least 10 g polyelectrolyte is present per square meter coated outer and/or inner surface of the wood material.

2. Coating according to claim 1, in which the coating comprises cationic and/or anionic polyelectrolytes or a mixture thereof.

3. Coating according to claim 2, in which the coating of cationic and anionic polyelectrolytes is dissolved and/or dispersed in a solvent and/or solvent mixture at least up to processing.

4. Coating according to claim 1, in which the polyelectrolytes are based on cellulose or cellulose derivatives.

5. Coating according to claim 1, in which at least 20 g cationic polyelectrolyte is present per square meter coated outer and/or inner surfaces of the wood material.

6. Coating according to claim 5, in which at least 30 to 50 g cationic polyelectrolyte is present per square meter coated outer and/or inner surfaces of the wood material.

7. Coating according to claim 1, in which the outer surface of a wood material is coated.

8. Coating according to claim 7, in which at least 80% of the outer surface of a wood material is coated, wherein a largely uniform distribution of the coating is realized.

9. Coating according to claim 1, in which the surfaces of the ground wood components of a wood material are coated as an inner surface.

10. Coating according to claim 1, in which the surfaces of the wood fibers of a wood fiber material are coated.

11. Coating according to claim 1, in which a largely uniform distribution of the coating on the inner surface of a wood material is present.

12. Coating according to claim 1, in which at least 80% of the inner surface of a wood material is coated, wherein at least a reticular connection between the coating materials is present in the form of a percolation network.

13. Coating according to claim 1, in which strong polyelectrolytes are present.

14. Coating according to claim 1, in which the polyelectrolyte or polyelectrolytes are dispersed in water and/or in organic solvents that have water-like properties.

15. Coating according to claim 14, in which ethanol and/or methanol and/or formic acid and/or acetic acid are present as organic solvents.

16. Method for producing a coating for wood materials, in which an aqueous solution and/or dispersion of a polyelectrolyte or a mixture of polyelectrolytes or a solution and/or dispersion of one or more organic solvents and of a polyelectrolyte or a mixture of polyelectrolytes or a solution and/or dispersion of aqueous organic solvents and of a polyelectrolyte or a mixture of polyelectrolytes is applied onto the outer and/or inner surface of wood materials, wherein at least 10 g cationized polyelectrolyte solid is applied per square meter coated outer and/or inner surface of the wood material.

17. Method according to claim 16, in which a polyelectrolyte or a mixture of only anionic or only cationic or anionic and cationic polyelectrolytes is used as a polyelectrolyte.

18. Method according to claim 16, in which polyelectrolytes based on cellulose or cellulose derivatives are used.

19. Method according to claim 16, in which the outer wood surfaces are coated.

20. Method according to claim 16, in which the surface of wood components that are processed to form a wood material are coated.

21. Method according to claim 18, in which wood fibers or wood chips are coated and subsequently compressed or further processed to form a wood material.

22. Method according to claim 16, in which an aqueous solution with a concentration of cationic and/or anionic polyelectrolytes of at least 10-30% is used.

23. Method according to claim 16, in which a solution of an organic solvent with a concentration of cationic and/or anionic polyelectrolytes of at least 10-30% is used.

24. Method according to claim 16, in which strong polyelectrolytes or mixtures thereof are used.

25. Method according to claim 16, in which the coating is applied onto the outer and/or inner surfaces of wood materials by spraying, pouring, knife coating, pressing, tumbling, swirling, dipping, mixing.

26. Method according to claim 16, in which the coated surfaces are dried.

27. Method according to claim 16, in which the coated surfaces are subsequently fed to a further processing.
